(19) United States
(12) Patent Application Publication
(10) Pub. No.: US 2011/0304784 A1
(43) Pub. Date: Dec. 15, 2011

(54) AREA LIGHT SOURCE DEVICE AND STEREOSCOPIC DISPLAY DEVICE

(75) Inventors: Kazuhide Hirota, Moriyama-shi (JP); Gouo Kurata, Kusatsu-shi (JP); Koichi Takemura, Konan-shi (JP); Yoshihiro Ueno, Kusatsu-shi (JP); Yu Kioka, Kyoto-shi (JP)

(73) Assignee: OMRON CORPORATION, Kyoto-shi (JP)

(21) Appl. No.: 13/157,860

(22) Filed: Jun. 10, 2011

(30) Foreign Application Priority Data
Jun. 11, 2010 (JP) 2010-134548

(51) Int. Cl. G02F 1/13357; F21V 8/00

(52) U.S. Cl. 349/15; 362/613; 362/608

(57) ABSTRACT

An area light source device has a first light guide plate, a first light source arranged facing a first end of the first light guide plate, a second light guide plate, and a second light source arranged facing a first end of the second light guide plate, the first light guide plate and the second light guide plate being overlapped to configure a light guide body. The first light guide plate and the second light guide plate are overlapped so that the first end face of the first light guide plate and a second end face positioned on an opposite side of the first end face of the second light guide plate are positioned on the same side.

### BACKGROUND OF THE INVENTION

1. Technical Field

The present invention relates to area light source devices and stereoscopic display devices. Specifically, the present invention relates to a stereoscopic display device for displaying images and videos three dimensionally, and an area light source device used in the stereoscopic display device.

2. Related Art

The stereoscopic display device for displaying a so-called three dimensional video includes a method of using a pair of observation glasses and a method of not using a pair of glasses. However, the method of using a pair of glasses is cumbersome since the observer needs to attach the pair of eyeglasses on the head, and the observer may also feel an uncomfortable feeling. The method of not using a pair of glasses is desired for the stereoscopic display device.

The stereoscopic display device not using the pair of glasses is disclosed in Japanese Patent Publication No. 3585781 and Japanese Patent Publication No. 3908241.

(Regarding Japanese Patent Publication No. 3585781)

A stereoscopic display device disclosed in Japanese Patent Publication No. 3585781 is shown in FIG. 1A. In such stereoscopic display device 11, a light guide plate 12a having a wedge shape and a light guide plate 12b similarly having a wedge shape are overlapped to form a light guide plate 12. The light guide plate 12a and the light guide plate 12b are overlapped through an air layer, where an end face on a thick thickness side of the light guide plate 12a and an end face on a thin thickness side of the light guide plate 12b have the left and right positions aligned, and an end face on a thin thickness side of the light guide plate 12a and an end face on a thick thickness side of the light guide plate 12b also have the left and right positions aligned. A left light source 13a faces the end face having a thick thickness of the light guide plate 12a. A right light source 13b faces the end face having a thick thickness of the light guide plate 12b. A prism sheet 14 is arranged on a front surface of the light guide body 12, and a liquid crystal panel 15 is arranged on the front surface thereof.

The liquid crystal panel 15 alternately displays a right eye image and a left eye image in a time division manner, where the left light source 13a emits light in synchronization with the left eye image (in this case, right light source 13b is turned OFF), and the right light source 13b emits light in synchronization with the right eye image (in this case, left light source 13a is turned OFF). As a result, in the stereoscopic display device 11, a left illumination light 16a emitted from the left light source 13a is converted to the left eye image to enter a left eye 17a of the observer, and a right illumination light 16b emitted from the right light source 13b is converted to the right eye image to enter a right eye 17b of the observer, so that the observer can recognize the stereoscopic video.

However, the light guide plates 12a, 12b are manufactured by resin molding. If the thickness of the end face on the thin thickness side of the light guide plates 12a, 12b is made too thin in this case, molding defect may occur at the relevant end face or chip may occur at the relevant end face in the manufacturing step or the assembly step of the stereoscopic display device 11. Therefore, an end face 18 on the thin thickness side of the light guide plates 12a, 12b actually has a thickness of a certain extent, respectively, as shown in FIG. 1B.

As a result, the stray light is generated from the light that entered form the end face 18 on the thickness side, which becomes a cause in the generation of crosstalk in the stereoscopic display device 11. The crosstalk is a phenomenon in which one part of the light from the left light source 13a is emitted in the same direction as the right illumination light 16b and the left eye image enters the right eye 17b of the observer, or one part of the light from the right light source 13b is emitted in the same direction as the left illumination light 16a and the right eye image enters the left eye 17a of the observer.

Specifically, as shown with a broken line in FIG. 1B, when one part of the light emitted from the right light source 13b enters the light guide plate 12a from the end face 18 of the thin thickness side of the light guide plate 12a, the incident light is guided through the light guide plate 12a as a stray light 16c and one part of such stray light 16c is exit towards the left eye 17a of the observer. Similarly, when one part of the light emitted from the left light source 13a enters the light guide plate 12b from the end face 18 of the thin thickness side of the light guide plate 12b, the stray light that entered the light guide plate 12b is guided through the light guide plate 12b, and one part of such stray light is exit towards the right eye 17b of the observer.

If such cross talk occurs, the right eye image is recognized not only with the right eye 17b but also with the left eye 17a of the observer at the time of the right eye image generation, and the left eye image is recognized not only with the left eye 17a but also with the right eye 17b of the observer at the time of the left eye image generation. As a result, the left eye image overlaps the right eye image recognized with the right eye to be seen doubly, and the right eye image overlaps the left eye image recognized with the left eye to be seen doubly, whereby the image becomes unclear.

As shown in FIG. 1B, consideration is made in limiting a light emitting direction of the left light source 13a and the right light source 13b so that light is emitted only from the front surface of each light source 13a, 13b to suppress such crosstalk. In the normal assembly accuracy, however, a gap is formed between the front surface of each light source 13a, 13b and the end face of each light guide plate 12a, 12b, and hence the light of each light source 13a, 13b that leaked from such gap inevitably enters the light guide plate 12b, 12a from the end face 18 on the thin thickness side.

(Regarding Japanese Patent Publication No. 3908241)

An area light source device 21 disclosed in Japanese Patent Publication No. 3908241 is shown in FIG. 2A. In the area light source device 21, a light guide plate 22a having a flat plate shape and a light guide plate 22b similarly having a flat plate shape are overlapped. A left light source 23a faces one end face of the light guide plate 22a. A right light source 23b faces one end face of the light guide plate 23b. The end face on a light source arranged side of the light guide plate 22a and an end face on the opposite side of the light source arranged side of the light guide plate 22b have the left and right positions aligned, and the end face on the opposite side of a light source arranged side of the light guide plate 22a and an end face on the light source arranged side of the light guide plate 22b have the left and right positions aligned.

In the area light source device 21 as well, the light emitted from the left light source 23a is guided through the light guide plate 22a and emitted as a left illumination light 26a towards the left eye of the observer, and the light emitted from the right light source 23b is guided through the light guide plate 22b and emitted as a right illumination light 26b towards the right eye.

However, even when such area light source device 21 is used, when the light from the right light source 23b not facing the light guide plate 22a enters the light guide plate 22, the incident light becomes a stray light 26c and one part of the stray light is exit in the direction of the left illumination light 26a, as shown with a broken line in FIG. 2B, similar to the stereoscopic display device of Japanese Patent Publication No. 3585781. Furthermore, when the light from the left light source 23a not facing the light guide plate 22b enters the light guide plate 22b, the incident light becomes a stray light and one part of the stray light is exit in the direction of the right illumination light 26b. The crosstalk consequently occurs, and as a result, the image is doubly viewed and is unclear even if the area light source device 21 of Japanese Patent Publication No. 3908241 is used.

### SUMMARY

One or more embodiments of the present invention suppresses the occurrence of crosstalk in a stereoscopic display device or an area light source device used in such device.

In accordance with one or more embodiments of the present invention, there is provided an area light source device including: a first light guide plate; a first light source arranged facing a first end of the first light guide plate; a second light guide plate; and a second light source arranged facing a first end of the second light guide plate, the first light guide plate and the second light guide plate being overlapped to configure a light guide body; wherein the first light guide plate and the second light guide plate are overlapped so that the first end face of the first light guide plate and a second end face positioned on the opposite side of the first end face of the second light guide plate are positioned on the same side, and a second end face positioned on the opposite side of the first end face of the first light guide plate and the first end face of the second light guide plate are positioned on the same side; and the second end face of the first light guide plate is shifted towards the second end face of the second light guide late than the first end face of the second light guide plate.

In the first area light source device according to one or more embodiments of the present invention, the light emitted from the second light source is less likely to enter the first light guide plate from the second end face since the second end face of the first light guide plate is retracted from the first end face of the second light guide plate. Therefore, the light of the second light source can be prevented from entering the first light guide plate and becoming a stray light, and the crosstalk can be suppressed when used in the stereoscopic display device.

In a first light source device according to one or more embodiments of the present invention, the second end face of the second light guide plate is shifted towards the second end face of the first light guide plate than the first end face of the first light guide plate. Accordingly, the light emitted from the first light source is less likely to enter the second light guide plate from the second end face since the second end face of the second light guide plate is also retracted from the first end face of the first light guide plate. Therefore, the light of the first light source can be prevented from entering the second light guide plate and becoming a stray light, and the crosstalk can be suppressed when used in the stereoscopic display device.

In accordance with one or more embodiments of the present invention, there is provided a second area light source device including: a first light guide plate; a first light source arranged facing a first end of the first light guide plate; a second light guide plate; and a second light source arranged facing a first end of the second light guide plate, the first light guide plate and the second light guide plate being overlapped to configure a light guide body; wherein the first light guide plate and the second light guide plate are overlapped so that the first end face of the first light guide plate and a second end face positioned on the opposite side of the first end face of the second light guide plate are positioned on an identical side, and a second end face positioned on the opposite side of the first end face of the first light guide plate and the first end face of the second light guide plate are positioned on an identical side; and the first light guide plate is positioned in a region optically hidden by the first end face of the second light guide plate when viewed from the second light source.

In the second area light source device according to one or more embodiments of the present invention, the light emitted from the second light source is less likely to enter the first light guide plate since the first light guide plate is positioned in a region optically hidden by the first end face of the second light guide plate (i.e., region that becomes the shade of the first end face of the second light guide plate) when viewed from the second light source. Therefore, the light of the second light source can be prevented from entering the first light guide plate and becoming a stray light, and the crosstalk can be suppressed when used in the stereoscopic display device.

In a second light source device according to one or more embodiments of the present invention, the second light guide plate is positioned in a region optically hidden by the first end face of the first light guide plate when viewed from the first light source. When referring to being positioned in a region optically hidden by the first end face of the first light guide plate, this means being arranged in a position where the light emitted from the first light source is shielded by the first end face of the first light guide plate and the light from the first light source does not reach or is hard to reach. According to the relevant embodiment, the light emitted from the first light source is less likely to enter the second light guide plate since the second light guide plate is positioned in a region optically hidden by the first end face of the first light guide plate (i.e., region that becomes the shade of the first end face of the first light guide plate) when viewed from the first light source. Therefore, the light of the first light source can be prevented from entering the second light guide plate and becoming a stray light, and the crosstalk can be suppressed when used in the stereoscopic display device.

In a first or second area light source device according to one or more embodiments of the present invention, the area light source device further includes a first wiring substrate mounted with the first light source and a second wiring substrate mounted with the second light source; wherein at least one part of the second wiring substrate is arranged in a space formed in the vicinity of the first end face in a surface on the side of the second light guide plate where the first light guide plate is overlapped. Accordingly, the end on the first light guide plate side in the gap formed between the first end face of the second light guide plate and the second light source can be shielded by the second wiring substrate. Therefore, the light of the second light source is less likely to leak to the first light guide plate side, and the crosstalk can be further suppressed when the area light source device is used in the stereoscopic display device.

In a first or second area light source device according to one or more embodiments of the present invention, the area light source device further includes a first wiring substrate mounted with the first light source and a second wiring substrate mounted with the second light source; wherein at least one part of the first wiring substrate is arranged in a space formed in the vicinity of the first end face in a surface on the side of the first light guide plate where the second light guide plate is overlapped. Accordingly, the end on the second light guide plate side in the gap formed between the first end face of the first light guide plate and the first light source can be shielded by the first wiring substrate. Therefore, the light of the first light source is less likely to leak to the second light guide plate side, and the crosstalk can be further suppressed when the area light source device is used in the stereoscopic display device.

In a first or second area light source device according to one or more embodiments of the present invention, a light absorbing member is arranged on the second end face of at least one of the second end face of the first light guide plate or the second end face of the second light guide plate. Accordingly, the light that entered into the first or second light guide plate from the first end face, guided through the first or second light guide plate and reached the second end face can be absorbed by the light absorbing member. The stray light by the return light at the second end face can be reduced, and the crosstalk by the stray light can be reduced. Furthermore, since the disturbance light, or the like can be prevented from entering from the second end face, the stray light by the disturbance light or the like that entered into the first or second light guide plate from the second end face can be reduced, and the crosstalk by the stray light can be reduced.

In a first or second area light source device according to one or more embodiments of the present invention, the second end face of the light guide plate is tilted with respect to the first end face of the light guide plate in at least one light guide plate of the first light guide plate and the second light guide plate. Accordingly, the return light returned by totally reflecting at the second end face can be reduced, so that the crosstalk that occurs when the return light becomes the stray light can be reduced. Furthermore, the manufacturing step does not increase compared to when the light absorbing member is arranged since the inclination of the second end face is merely changed when molding the first light guide plate or the second light guide plate.

In accordance with one or more embodiments of the present invention, there is provided a stereoscopic display device including: first or second area light source device according to one or more embodiments of the present invention; an optical sheet and a liquid crystal panel arranged on a front side of the liquid crystal panel; and a synchronous drive device for alternately switching a display of the liquid crystal panel to a right eye image and a left eye image and alternately switching light-ON or light-OFF of the first light source and the second light source of the area light source device in synchronization with the switching of the image. According to the stereoscopic display device, the stereoscopic video generated by the stereoscopic display device becomes clearer since the crosstalk can be reduced.

### BRIEF DESCRIPTION OF THE DRAWINGS

FIG. 1A is a schematic view showing a structure of a stereoscopic display device disclosed in Japanese Patent Publication No. 3585781, and FIG. 1B is a view describing the reasons crosstalk occurs in the stereoscopic display device of FIG. 1A;

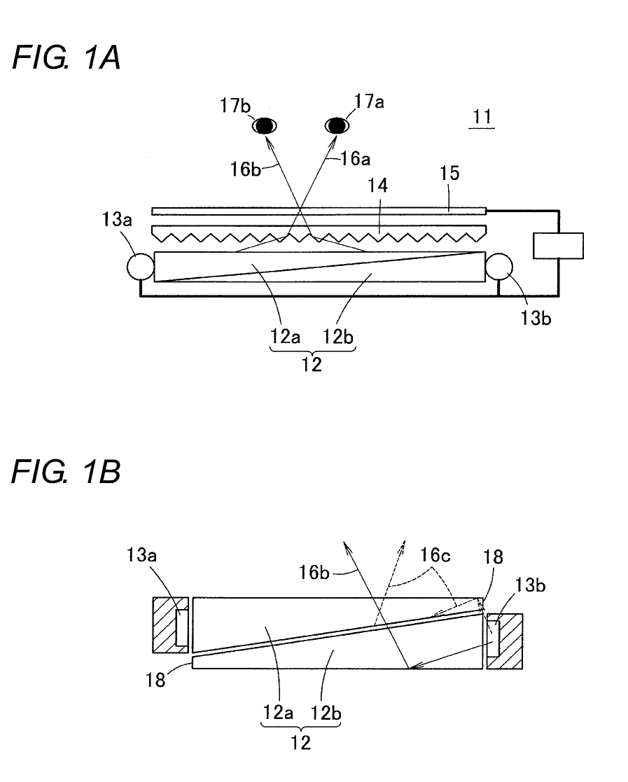

FIG. 2A is a schematic view showing an area light source device for stereoscopic display disclosed in Japanese Patent Publication No. 3908241, and FIG. 2B is a view describing the reasons crosstalk occurs in the area light source device of FIG. 2A;

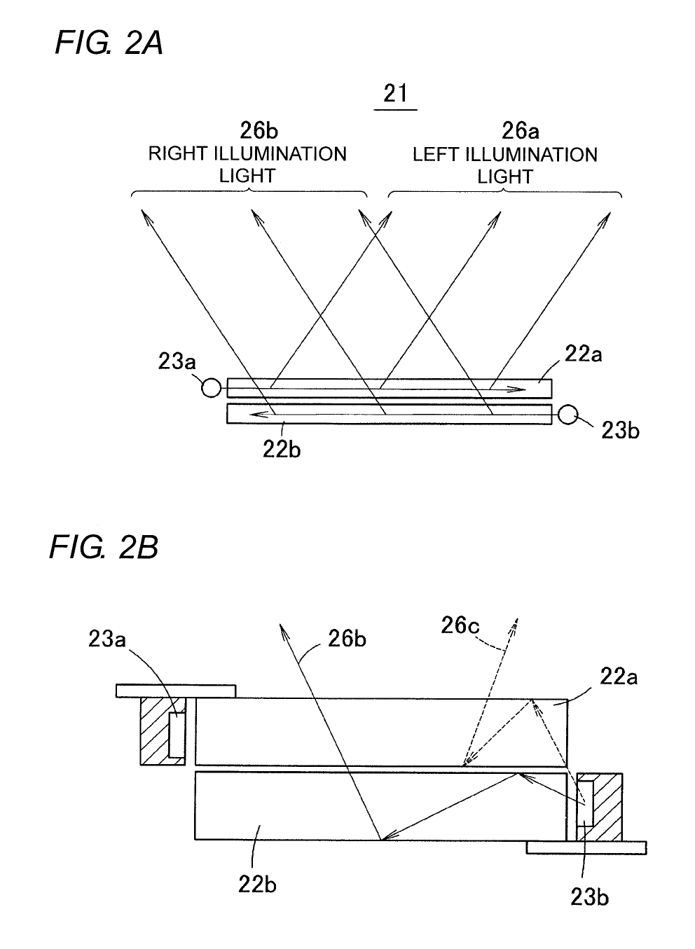

FIG. 3 is a schematic cross-sectional view showing a structure of an area light source device according to a first embodiment of the present invention;

FIG. 4 is a perspective view showing one light guide plate and a left light source (or other light guide plate and right light source);

FIGS. 5A and 5B are enlarged views of portion A in FIG. 3 and describe the effects of a light absorbing member;

FIG. 6 is a schematic cross-sectional view showing one example of a stereoscopic display device using the area light source device of the first embodiment;

FIGS. 7A, 7B, and 7C are explanatory views describing the arrangement of a pair of light guide plates;

FIG. 8 is a perspective view of an optical sheet;

FIG. 9 is an explanatory view describing the action of the optical sheet;

FIGS. 10A, 10B, and 10C are schematic views showing an area light source device according to a variant of the first embodiment;

FIG. 11 is a schematic cross-sectional view showing a structure of an area light source device according to a second embodiment of the present invention;

FIG. 12 is a perspective view of one of the light guide plates and a left light source (or the other light guide plate and a right light source) used in the area light source device of the second embodiment;

FIG. 13 is a perspective view showing another example of one of the light guide plates and a left light source (or the other light guide plate and a right light source) used in the area light source device of the second embodiment;

FIG. 14 is a perspective view showing another further example of one of the light guide plates and a left light source (or the other light guide plate and a right light source) used in the area light source device of the second embodiment;

FIG. 15 is a perspective view showing another further example of one of the light guide plates and a left light source (or the other light guide plate and a right light source) used in the area light source device of the second embodiment;

FIG. 16 is a schematic cross-sectional view showing a structure of an area light source device according to a third embodiment of the present invention;

FIG. 17A is a schematic cross-sectional view showing a structure of an area light source device according to a fourth embodiment of the present invention, and FIG. 17B is a schematic cross-sectional view showing an embodiment for comparing with the area light source device of the fourth embodiment; and

FIGS. 18A and 18B are schematic views showing an area light source device according to a variant of the fourth embodiment.

### DETAILED DESCRIPTION

Hereinafter, embodiments of the present invention will be described with reference to the accompanied drawings. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention. It should be recognized that the present invention is not limited to the following embodiments, and various design changes may be made within a scope not deviating from the gist of the present invention.

### First Embodiment

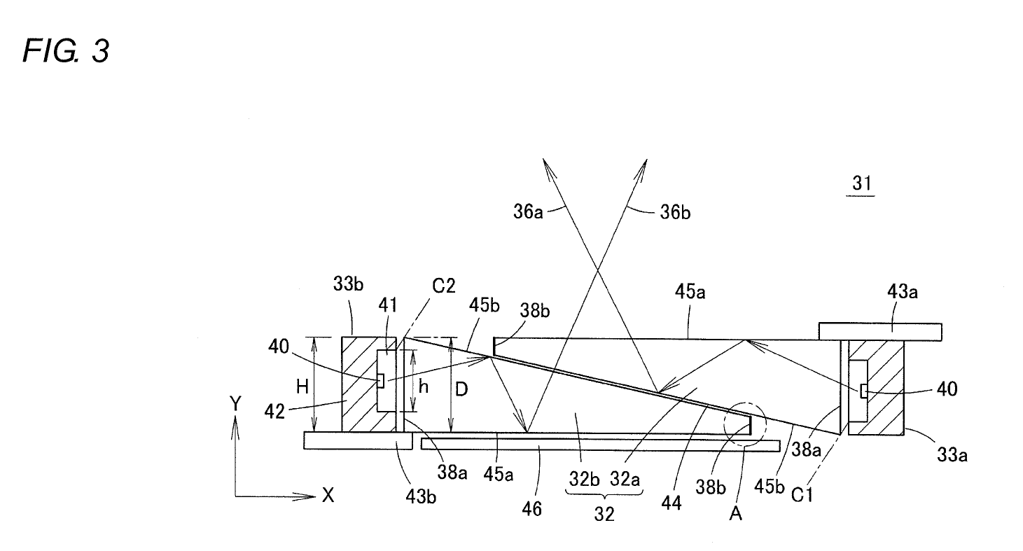

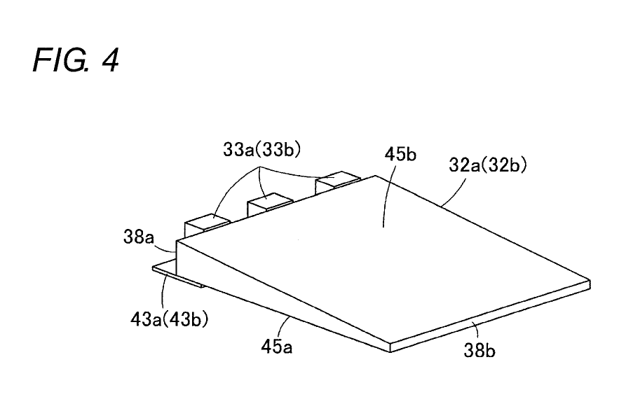

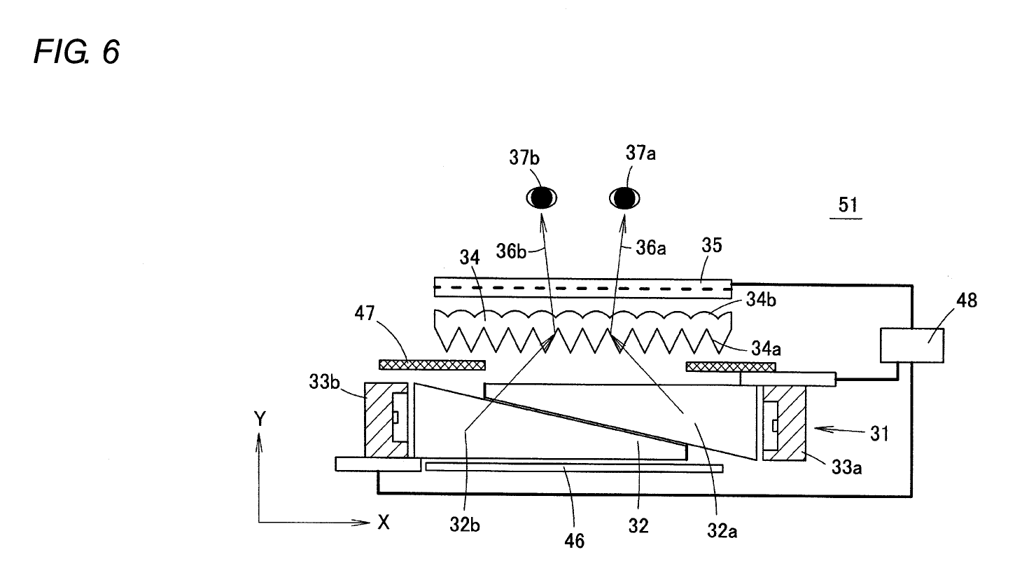

An area light source device 31 and a stereoscopic device 51 according to a first embodiment of the present invention will be described below with reference to FIGS. 3 to 9. FIG. 3 is a schematic cross-sectional view showing the area light source device 31 of the first embodiment. FIG. 4 is a perspective view showing one light guide plate 32a and a left light source 33a (or other light guide plate 32b and right light source 33b). FIG. 6 is a schematic cross-sectional view of the stereoscopic display device 51 of the first embodiment.

In the area light source device 31 shown in FIG. 3, the light guide plate 32a (one light guide plate of first light guide plate and second light guide plate) and the light guide plate 32b (other light guide plate of first light guide plate and second light guide plate) are overlapped to form a light guide body 32. The light guide plate 32a and the light guide plate 32b are molded to a substantially wedge shape in which a thickness of one end face is thicker than a thickness of the other end face from a translucent resin having high index of refraction such as polycarbonate resin or polymethyl methacrylate resin. In other words, both the light guide plate 32a and the light guide plate 32b have a substantially wedge shape surrounded by a flat surface 45a, end faces 38a, 38b and side surfaces substantially perpendicular to the flat surface 45a, and an inclined surface 45b facing the flat surface 45a, as shown in FIG. 4. In each light guide plate 32a, 32b, one end face 38a has a greater thickness than the other end face 38b, but the cross-sectional shape of the other end face 38b is not a molded to a pointed end but has a thickness of a certain extent even with the end face 38b on a thin thickness side to improve molding property.

As shown in FIG. 3, the light guide plate 32a and the light guide plate 32b are overlapped so that the end face 38a on a thick thickness side and the end face 38b on the thin thickness side are positioned on opposite sides to each other and so that the inclined surfaces 45b face each other, and thus a front surface and a rear surface of the light guide body 32 (i.e., flat surfaces 45a of the light guide plates 32a, 32b) are parallel. However, the inclined surfaces 45b are not directly attached and are overlapped with a low refraction layer 44 (e.g., air layer, transparent adhesive layer, transparent liquid layer, etc.) having a smaller index of refraction than the light guide plates 32a, 32b in between.

In the overlapped light guide plate 32a and the light guide plate 32b, the end face 38b on a thin thickness side of the light guide plate 32a has the position in a left and right direction shifted with respect to the end face 38a on a thick thickness side of the plate guide plate 32b so as to be retracted than the end face 38a of the light guide plate 32b. Similarly, the end face 38b on a thin thickness side of the light guide plate 32b also has the position in the left and right direction shifted with respect to the end face 38a on a thick thickness side of the plate guide plate 32a so as to be retracted than the end face 38a of the light guide plate 32a. In particular, in the embodiment shown in FIG. 3, the back end edge of the end face 38a of the light guide plate 32a is positioned on the extension of the flat surface 45a of the light guide plate 32b, and the front end edge of the end face 38a of the light guide plate 32b is positioned on the extension of the flat surface 45a of the light guide plate 32a, so that a thickness of the light guide plate 32 is the thinnest. In FIG. 3 and FIG. 6, an X direction represents a left and right direction, and a Y direction represents a front and back direction.

A reflection member 46 is arranged on the rear surface of the light guide body 32. The reflection member 46 is formed from a material having high reflectance such as white resin sheet or metal foil to reflect the light leaked from the rear surface of the light guide plate 32 to reenter the light guide body 32 thus reducing the leakage light and enhancing the light usage efficiency.

The left light source 33a (one light source of first light source and second light source) and the right light source 33b (other light source of first light source and second light source) are both configured by one or a plurality of LED light sources. In other words, an LED chip 40 is sealed inside a transparent resin 41, and each surface excluding the front surface of the transparent resin 41 is covered with a coating portion 42 made of white resin in the light sources 33a, 33b. Therefore, when the LED chip 40 emits light, the light emitted from the LED chip 40 is passed through the transparent resin 41 and directly exit to the outside from a light exit window at the front surface, or is reflected at an interface of the transparent resin 41 and the coating portion 42 and then exit to the outside from the light exit window at the front surface. The left light source 33a is mounted on the surface of one flexible print substrate 43a (one wiring substrate of first wiring substrate and second wiring substrate), and the right light source 33b is mounted on the surface of another flexible print substrate 43b (other wiring substrate of first wiring substrate and second wiring substrate).

The left light source 33a is arranged so that the light exit window faces the end face 38a (light incident surface) on the thick thickness side of the light guide plate 32a. Similarly, the right light source 33b is arranged so that the light exit window faces the end face 38b (light incident surface) on the thick thickness side of the light guide plate 32b. The left light source 33a and the right light source 33b are controlled to alterably repeat light ON and light OFF at a constant period. A thickness D of the end face 38a of the light guide plates 32a, 32b is desirably smaller than or equal to a height H of each light source 33a, 33b to reduce a thickness of the light guide body 32. Furthermore, the thickness D of the end face 38a of the light guide plates 32a, 32b is desirably greater than or equal to the height h of the light exit window of each light source 33a, 33b in order to efficiently enter the light emitted from each light source 33a, 33b to the end face 38a of each light guide plate 32a, 32b and reduce to the loss of light.

The flexible print substrates 43a, 43b may be positioned on opposites sides from FIG. 3. In other words, the flexible print substrate 43a (or flexible print substrate 43b) may cover the end of the gap between the end face 38a of the light guide plate 32a (or light guide plate 32b) and the left light source 33a (or right light source 33b) on the side the light guide plate 32b (or light guide plate 32a) is overlapped. A cold cathode tube may be used for the left light source 33a and the right light source 33b.

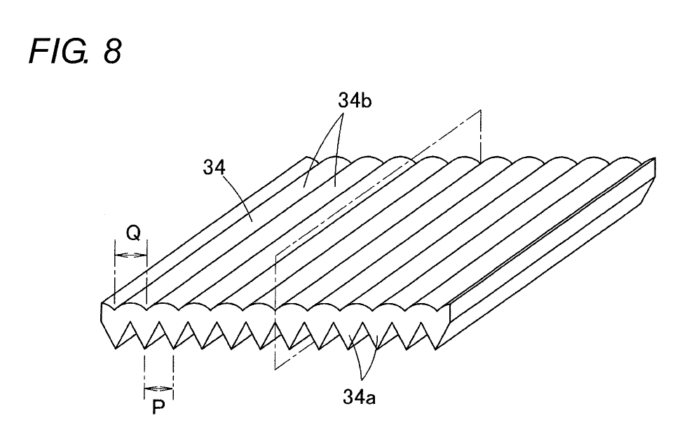

A structure of the stereoscopic device 51 using the area light source device 31 described above is shown in FIG. 6. In such stereoscopic display device 51, a rim sheet 47 is laminated to the front surface of the light guide body 32. The rim sheet 47 is a light absorbing member formed by a black adhesive tape, or the like in which a region corresponding to an effective region of the light guide body 32 is opened, the rim sheet 47 covering the periphery of the light guide body 32. Furthermore, an optical sheet 34 and a liquid crystal panel 35 are overlapped at the front side of the opening of the rim sheet 47. As shown in FIG. 8, a prism pattern 34a of a microscopic triangular prism shape having a uniform cross-sectional shape along a direction (up and down direction) orthogonal to the X direction and the Y direction is arrayed at a constant pitch P along the X direction on the rear surface of the optical sheet 34. A lens pattern 34b of a microscopic convex lens shape having a uniform cross-section shape along a direction orthogonal to the X direction and the Y direction is arrayed at a constant pitch Q along the X direction on the front surface of the optical sheet 34. The array pitch Q of the lens pattern 34b is slightly larger than the array pitch P of the prism pattern 34a. The prism pattern 34a is arranged to be symmetric with respect to a plane passing through the center of the optical sheet 34 in the X direction and being perpendicular to the optical sheet 34, and the lens pattern 34b is also arranged to be symmetric with respect to a plane passing through the center of the optical sheet 34 in the X direction and being perpendicular to the optical sheet 34. The liquid crystal panel 35 alternately displays the image (right eye image) in a case where the observer views with the right eye and the image (left eye image) in a case where the observer views with the left eye.

The video of the liquid crystal panel 35, and the light ON/light OFF of the left light source 33a and the right light source 33b are synchronously controlled by a synchronous drive device 48. The synchronous drive device 48 alternately displays on the liquid crystal panel 35 the left eye image and the right eye image in a short period of an extent the observer cannot recognize the switching of the left and right images, turns ON the left light source 33a (turns OFF right light source 33b) in synchronization of the left eye image of the liquid crystal panel 35, and turns ON the right left source 33b (turns OFF left light source 33a) in synchronization with the right eye image.

As shown in FIG. 3, when the right light source 33b is turned ON, the light (white light) emitted from the right light source 33b enters the light guide plate 32b from the end face 38a, and is guided through the light guide plate 32b while being totally reflected by the flat surface 45a and the inclined surface 45b of the light guide plate 32b. The light guided through the light guide plate 32b is reflected by the flat surface 45a so that the incident angle with respect to the inclined surface 45b becomes smaller, whereby the light which incident angle with respect to the inclined surface 45b became smaller than the critical angle of total reflection is exit from the inclined surface 45b of the light guide plate 32b, and further transmitted through the light guide plate 32a and exit to the front side. As a result, a right illumination light 36b, in which the direction of maximum intensity is aligned, is exit towards a certain direction from the entire effective region of the light guide body 32. The right illumination light 36b exit from the light guide body 32 is bent by the optical sheet 34 to enter the liquid crystal panel 35 so that the light that transmitted through each pixel is collected at the right eye 37b of the observer positioned at a substantially predetermined distance from the liquid crystal panel 35. The right illumination light 36b is converted to the right eye image by being transmitted through the liquid crystal panel 35, and is recognized by the right eye 37b of the observer.

Similarly, when the left light source 33a is turned ON, the light (white light) emitted from the left light source 33a enters the light guide plate 32a from the end face 38a, and is guided through the light guide plate 32a while being totally reflected by the flat surface 45a and the inclined surface 45b of the light guide plate 32a. The light guided through the light guide plate 32a is reflected by the inclined surface 45b so that the incident angle with respect to the flat surface 45a becomes smaller, whereby the light which incident angle with respect to the flat surface 45a became smaller than the critical angle of total reflection is exit from the flat surface 45a of the light guide plate 32a. As a result, a left illumination light 36a, in which the direction of maximum intensity is aligned, is exit towards a certain direction from the entire effective region of the light guide body 32. The left illumination light 36a exit from the light guide body 32 has a direction bent by the optical sheet 34 to enter the liquid crystal panel 35 so that the light that transmitted through each pixel is collected at the left eye 37a of the observer. The left illumination light 36a is converted to the left eye image by being transmitted through the liquid crystal panel 35, and is recognized by the left eye 37a of the observer.

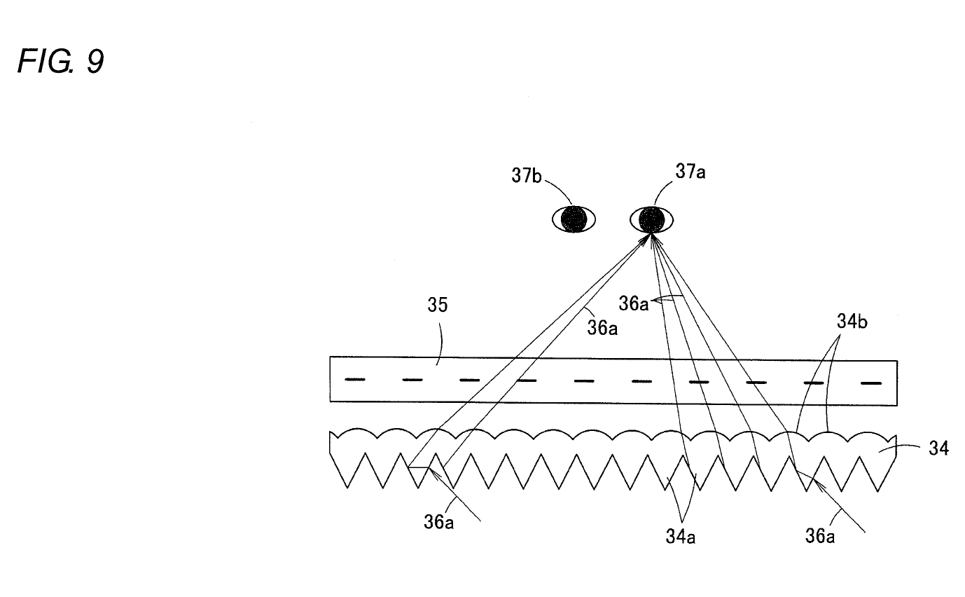

FIG. 9 shows the optical effects of the optical sheet 34 in detail. The optical sheet 34 has the prism pattern 34a and the lens pattern 34b arranged symmetrically, and has the pitch Q of the lens pattern 34b made slightly larger than the pitch P of the prism pattern 34a, so that the center of each lens pattern 34b is shifted from the center of the corresponding prism pattern 34a. Therefore, as shown in FIG. 9, the left illumination light 36a that entered the prism pattern 34a has a light ray direction bent by the prism pattern 34a, and further bent in a direction of the left eye 37a by the lens pattern 34b when transmitting through the lens pattern 34b. Moreover, the shift between the center of the lens pattern 34b and the center of the prism pattern 34a becomes greater towards the end of the optical sheet 34, so that the left illumination light 36a transmitting through the lens pattern 34b is converged and collected at the left eye 37a. The right illumination light 36b is converged to the right eye 37b by transmitting through the optical sheet 34 by the similar action.

The left eye image and the right eye image are thus alternately transmitted to the left eye 37a and the right eye 37b of the observer, but the three dimensional video (stereoscopic video) is recognized since the observer simultaneously recognizes the right eye image and the left eye image due to residual image effect.

The light guides plates 32a, 32b may be formed with a microscopic optical pattern on at least one of the flat surface 45a and the inclined surface 45b. Since the light guide plates 32a, 32b have a substantially wedge shape, the light exits from the flat surface 45a or the inclined surface 45b even if the optical pattern is not provided, but the light easily exits from the light guide body 32 by providing the optical pattern. As a result, the return light reflected at the end face 38b of the light guide plate 32a, 32b and returned is reduced, and the crosstalk can be suppressed. Moreover, the luminance distribution at the entire effective region of the light guide plate 32 can be uniformed by providing the optical pattern and adjusting the arrangement and the density of the optical pattern.

In the area light source device 31, the light emitted from the left light source 33a is less unlikely to enter the light guide plate 32b from the end face 38b since the end face 38b of the light guide plate 32b is retracted than the end face 38a of the light guide plate 32a. Similarly, the light emitted from the right light source 33b is less unlikely to enter the light guide plate 32a from the end face 38b since the end face 38b of the light guide plate 32a is retracted than the end face 38a of the light guide plate 32b. Therefore, the light that entered the light guide plate 32b or the light guide plate 32a from the end face 38b becomes a stray light, so that the crosstalk can be suppressed from occurring in the stereoscopic video of the stereoscopic display device 51 and the stereoscopic video can be made clearer.

The extent that the light guide plate 32b (or end face 38b thereof) is retracted from the end face 38a of the light guide plate 32a may be such that the light guide plate 32b is retracted to the region that becomes the shade of the light guide plate 32a. The region that becomes the shade of the light guide plate 32a is the region on the side close to the right light source 33b than a line segment C1 connecting the back end of the light exit window of the left light source 33a and the back end of the end face 38a of the light guide plate 32a in the cross section of FIG. 3. Similarly, the extent that the light guide plate 32a (or end face 38b thereof) is retracted from the end face 38a of the light guide plate 32b may be such that the light guide plate 32a is retracted to the region that becomes the shade of the light guide plate 32b. The region that becomes the shade of the light guide plate 32b is the region on the side close to the left light source 33a than a line segment C2 connecting the front end of the light exit window of the right light source 33b and the front end of the end face 38a of the light guide plate 32b in the cross section of FIG. 3. Therefore, if the light guide plate 32b (or light guide plate 32a) is in the region that becomes the shade of the light guide plate 32a (or light guide plate 32b), the light emitted from the left light source 33a (or right light source 33b) does not reach the end face 38b of the light guide plate 32b (or light guide plate 32a) by being shielded by the light guide plate 32a (or light guide plate 32b), and hence the crosstalk from the stray light can be prevented.

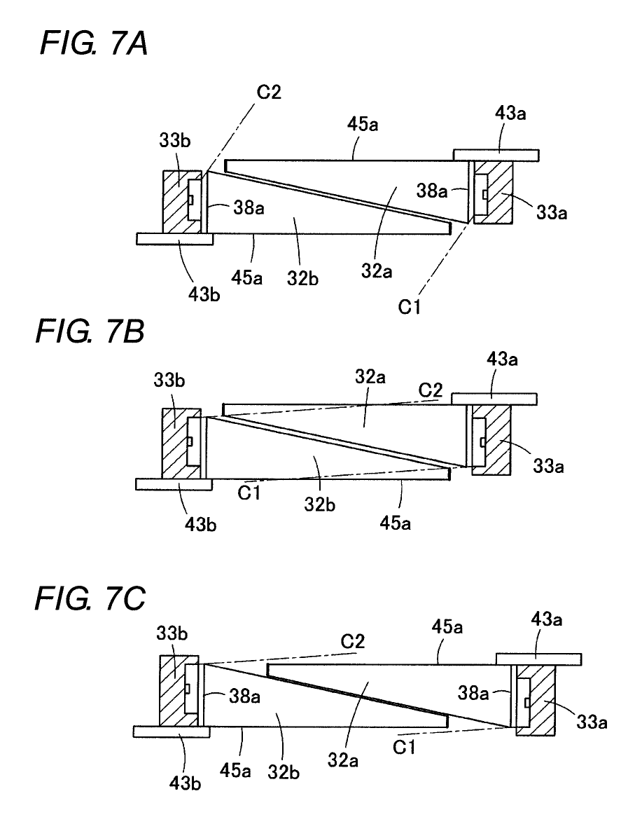

In order to prevent the crosstalk, the light guide plate 32b (or light guide plate 32a) merely needs to be in the region that becomes the shade of the light guide plate 32a (or light guide plate 32b), and thus the flat surface 45a of the light guide plate 32b may be projected out than the back end of the end face 38a of the light guide plate 32a, and the flat surface 45a of the light guide plate 32a may be projected out than the front end of the end face 38a of the light guide plate 32b, as shown in FIG. 7A

However, if the flat surface 45a of the light guide plate 32b is projected out, as shown in FIG. 7B, the light guide plate 32b may run out from the region that becomes the shade of the light guide plate 32a over the line segment C1 if the back end of the light exit window of the left light source 33a approaches the back end of the end face 38a of the light guide plate 32a due to a manufacturing error and an assembly error. The relationship between the light guide plate 32a and the right light source 33b is similar.

If the back end of the end face 38a of the light guide plate 32a is on the extension of the flat surface 45a of the light guide plate 32b as in the area light source device 31 of FIG. 3, on the other hand, the possibility that the light guide plate 32b will run out from the region that becomes the shade of the light guide plate 32a over the line segment C1 becomes smaller even if the back end of the light exit window of the left light source 33a is shifted to the back end side of the end face 38a of the light guide plate 32a, as shown in FIG. 7C. Similarly, if the front end of the end face 38a of the light guide plate 32b is on the extension of the flat surface 45a of the light guide plate 32a, the possibility the light guide plate 32a will run out from the region that becomes the shade of the light guide plate 32b over the line segment C2 becomes smaller even if the front end of the light exit window of the right light source 33b is shifted to the front end side of the end face 38a of the light guide plate 32b, as shown in FIG. 7C.

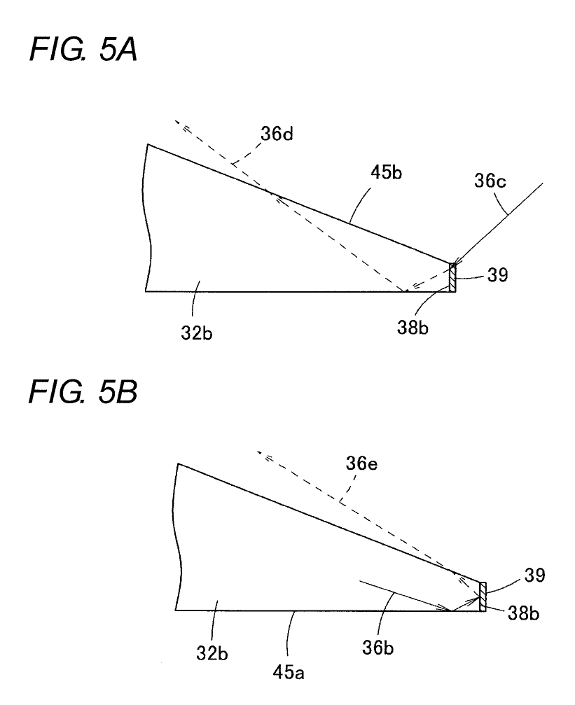

The end face 38b of the light guide plate 32a and the end face 38b of the light guide plate 32b may be covered with a light absorbing member 39. If the light absorbing member 39 is formed on each end face 38b, the disturbance light 36c (or leakage light of illumination light 36a, 36b) that entered the end face 38b can be shielded and prevented from entering the light guide plate 32b (or light guide plate 32a), as shown in FIG. 5A. Therefore, the disturbance light 36c that entered the light guide plate 32a, 32b can be prevented from becoming a stray light 36d and causing crosstalk. When the right illumination light 36b (or left illumination light 36a) that entered from the end face 38a (light incident surface 36a) is guided through the light guide plate 32b (or light guide plate 32a) and entered to the end face 38b, such light can be absorbed to suppress reflection, as shown in FIG. 5B. Therefore, the return light reflected at the end face 38b can be prevented from becoming a stray light 36e and causing crosstalk.

With the structure described above, according to the area light source device 31, a clear stereoscopic video can be displayed by the stereoscopic display device 51 while suppressing crosstalk.

### Variant of First Embodiment

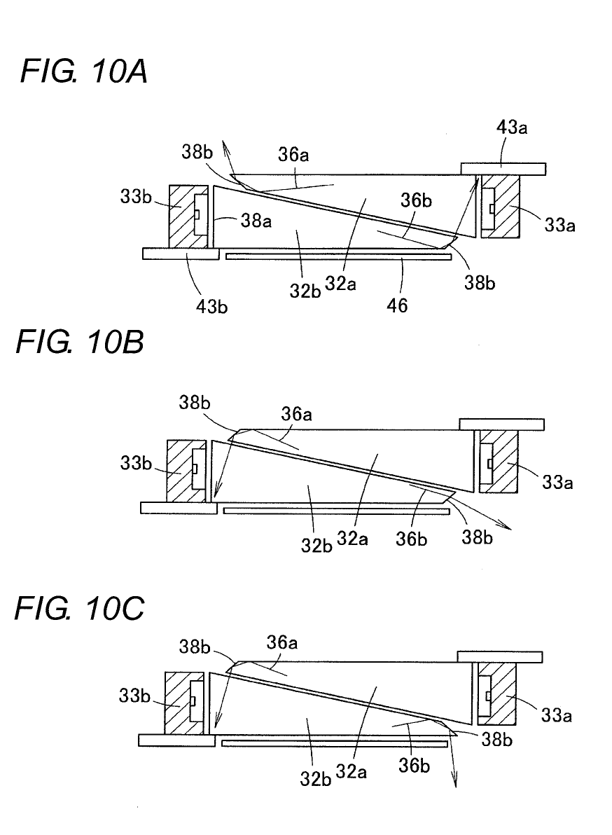

FIGS. 10A to 10C are views showing a variant of the first embodiment of the present invention. In the figures, the end face 38b of the light guide plates 32a, 32b is inclined so as to be non-parallel with respect to the end face 38a.

In the area light source device of FIG. 10A, the end face 38b of the light guide plate 32a is inclined to become farther away from the end face 38a towards the front side (towards liquid crystal panel). Therefore, the light guided through the light guide plate 32a and reached the end face 38b is totally reflected at the end face 38b and is less likely to return in an original direction, and is easily exit to the outside of the light guide plate 32a by being totally reflected at the end face 38b or by transmitting through the end face 38b. The end face 38b of the light guide plate 32b is also inclined to become farther away from the end face 38a towards the front side. Therefore, the light guided through the light guide plate 32b and reached the end face 38b is totally reflected at the end face 38b and is less likely to return to the original direction, and is easily exit to the outside of the light guide plate 32b by being totally reflected at the end face 38b or by transmitting through the end face 38b.

In the area light source device of FIG. 10B, the end face 38b of the light guide plate 32a is inclined to become closer to the end face 38a towards the front side. Therefore, the light guided through the light guide plate 32a and reached the end face 38b is totally reflected at the end face 38b and is less likely to return to the original direction, and is easily exit to the outside of the light guide plate 32a by being totally reflected at the end face 38b or by transmitting through the end face 38b. The end face 38b of the light guide plate 32b is also inclined to become farther away from the end face 38a towards the front side. Therefore, the light guided through the light guide plate 32b and reached the end face 38b is totally reflected at the end face 38b and is less likely to return to the original direction, and is easily exit to the outside of the light guide plate 32b by being totally reflected at the end face 38b or by transmitting through the end face 38b.

In the area light source device of FIG. 10C, the end face 38b of the light guide plate 32a is inclined to become closer to the end face 38a towards the front side. Therefore, the light guided through the light guide plate 32a and reached the end face 38b is totally reflected at the end face 38b and is less likely to return to the original direction, and is easily exit to the outside of the light guide plate 32a by being totally reflected at the end face 38b or by transmitting through the end face 38b. The end face 38b of the light guide plate 32b is also inclined to become closer to the end face 38a towards the front side. Therefore, the light guided through the light guide plate 32b and reached the end face 38b is totally reflected at the end face 38b and is less likely to return to the original direction, and is easily exit to the outside of the light guide plate 32b by being totally reflected at the end face 38b or by transmitting through the end face 38b.

In the area light source device as shown in FIGS. 10A to 10C, the light totally reflected at the end face 38b becomes the return light to return to the original direction and is exit in a direction different from the original direction so as to be prevented from becoming the cause of crosstalk. Since the end face 38b is merely inclined when manufacturing a die for molding the light guide plates 32a, 32b, the manufacturing steps do not increase as when forming the light absorbing member 39 at the end face 38b of the light guide plates 32a, 32b, and the manufacturing cost can be suppressed.

A direction of inclining the end face 38b is not limited to those shown in FIGS. 10A to 10C.

### Second Embodiment

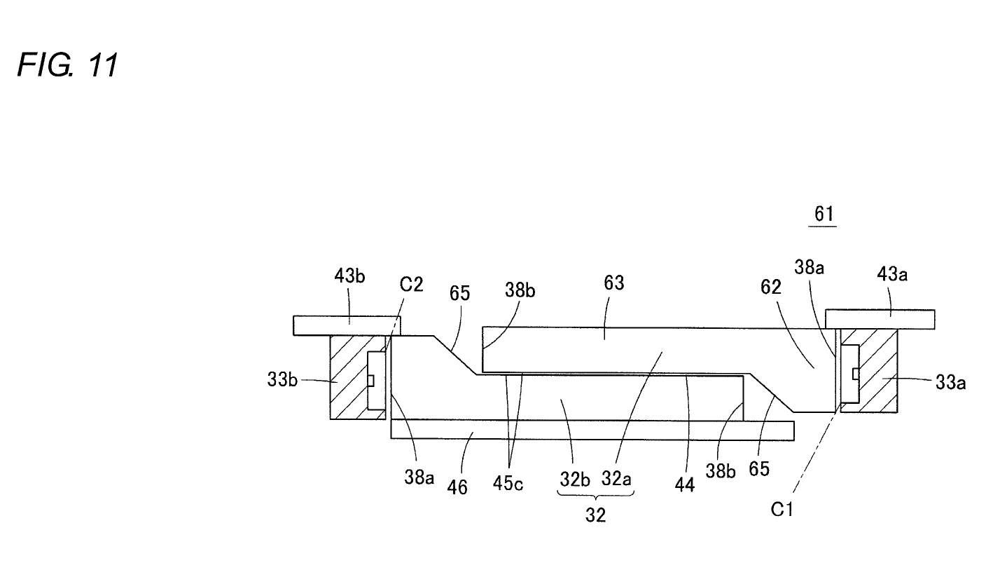

FIG. 11 is a schematic cross-sectional view showing an area light source device 61 according to a second embodiment of the present invention. The area light source device 61 differs from the area light source device 31 of the first embodiment in the shapes of the light guide plate 32a and the light guide plate 32b.

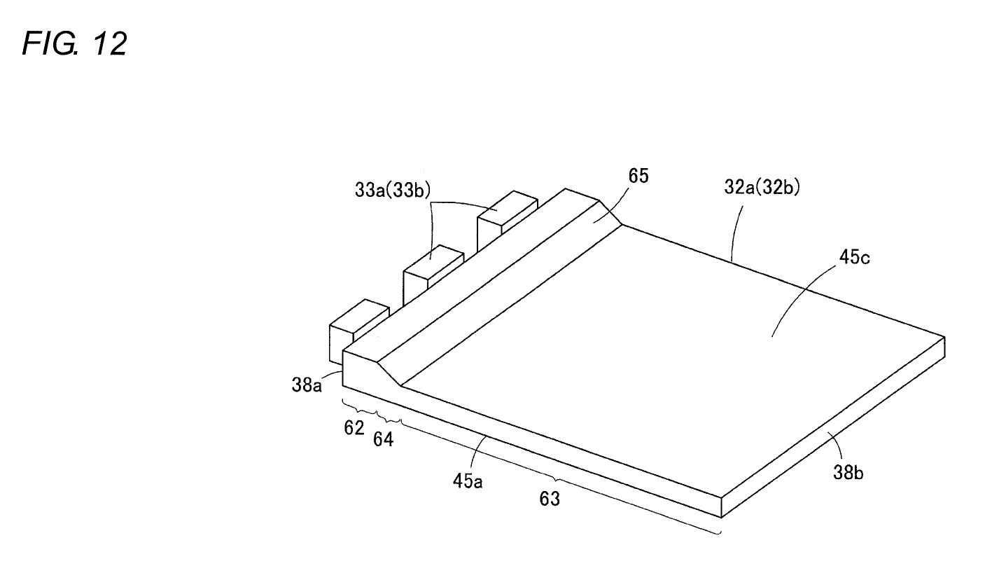

As shown in FIG. 12, the light guide plates 32a, 32b used in the area light source device 61 are configured by a light introducing unit 62 having a thick plate thickness, a light guide plate main body 63 having a thin plate thickness, and a light transitioning unit 64 for connecting the light introducing unit 62 and the light guide plate main body 63. The lower surfaces of the light guide plates 32a, 32b are flat surfaces 45a, where the upper surface facing the flat surface 45a of the light introducing unit 62 is a plane substantially parallel to the flat surface 45a, the surface facing the flat surface 45a of the light guide plate main body 63 is also a flat surface 45c substantially parallel to the flat surface 45a, and the surface facing the flat surface 45a of the light transitioning unit 64 is an inclined surface 65 inclined downward from the upper surface of the light introducing unit 62 towards the flat surface 45c of the light guide plate main body 63. A thickness of the light introducing unit 62 is thicker than the height of the light exit window of the light source 33a, 33b, and thinner than the height of the light source 33a, 33b. The light guide plate main body 63 has a thickness of substantially ½ of the thickness of the light introducing unit 62, and a microscopic optical pattern (e.g., prism pattern depressed to triangular cross-section or the like is arrayed in parallel or in arcuate form) for exiting the light towards the outside from the light exit surface (surface facing liquid crystal panel side of flat surfaces 45a, 45c) of the light guide plate main body 63 is formed on at least one of the flat surfaces 45a, 45c of the light guide plate main body 63.

The light guide plate 32a and the light guide plate 32b have the light guide plate 32b turned upside down and the light introducing unit 62 side and the light guide plate main body 63 side are positioned on opposite sides to each other, so that the flat surfaces 45c of the light guide plate main body 63 are overlapped through a low refraction index layer 44. Therefore, the projecting portion of the light introducing unit 62 faces the inner side and does not project out to the outer surface of the light guide body 32 even in the light guide plate 32a and in the light guide plate 32b. The light guide plate 32a is arranged retracted from the end face 38a of the light guide plate 32b so as to fit within a region that becomes the shade of the light guide plate 32b, and the light guide plate 32b is arranged retracted from the end face 38a of the light guide plate 32a so as to fit within a region that becomes the shade of the light guide plate 32a. The left light source 33a is arranged facing the end face 38a on the light introducing unit 62 side of the light guide plate 32a, and the right light source 33b is arranged facing the end face 38a on the light introducing unit 62 side of the light guide plate 32b. In FIG. 11, the flexible print substrate 43a mounted with the left light source 33a is positioned on the front surface side of the left light source 33a, but may be arranged on the rear surface side of the left light source 33a.

In the area light source device 61, the thickness of the light introducing unit 62 is substantially equal to the height of the light sources 33a, 33b, so that the light emitted from the light sources 33a, 33b can be efficiently entered to the light guide plates 32a, 32b and the usage efficiency of the light can be enhanced. Since a thickness of the light guide plate main body 63 occupying the majority of the region of the light guide plates 32a, 32b is thin, the thickness of the light guide plate 32 when the light guide plates 32a, 32b are overlapped can be thinned. Furthermore, the light entered to the light introducing unit 62 can be efficiently guided to the light guide plate main body 63 while being totally reflected by the flat surface 45a and the inclined surface 65 since the upper surface of the light transitioning unit 64 positioned between the light introducing unit 62 and the light guide plate main body 63 is the inclined surface 65.

The end face 38b of the light guide plate 32b is retracted from the end face 38a of the light guide plate 32a and the light guide plate 32b is positioned in a region (left side from line segment C1 in FIG. 11) that becomes the shade of the light guide plate 32a, and the end face 38b of the light guide plate 32a is retracted from the end face 38a of the light guide plate 32b and the light guide plate 32a is positioned in a region (right side from line segment C2 in FIG. 11) that becomes the shade of the light guide plate 32b, so that the crosstalk can be reduced when used in the stereoscopic display.

### Variant of Second Embodiment

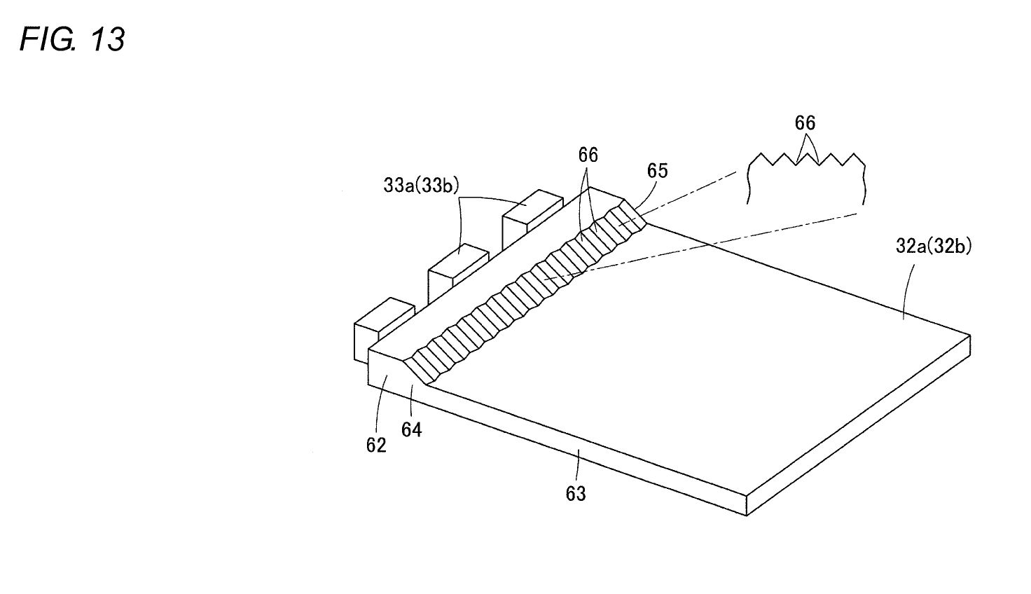

FIG. 13 is a perspective view showing another example of the light guide plate 32a (or light guide plate 32b) used in the area light source device 61 of the second embodiment. In FIG. 13, the cross-section of a V groove 66 is also shown. In the light guide plate 32a (or light guide plate 32b) of FIG. 13, a plurality of microscopic V grooves 66 is arrayed in parallel and continuously to each other along the inclined surface 65 of the light transitioning unit 64. When such light guide plate 32a, 32b is used, the light that entered to the inclined surface 65 from the light introducing unit 62 can be regressively reflected by the V groove 66, and hence the light that leaks from the inclined surface 65 in the middle of guiding the light that entered the light introducing unit 62 to the light guide plate main body 63 can be reduced, and the light usage efficiency can be enhanced. The luminance of the area light source device 61 thus can be enhanced.

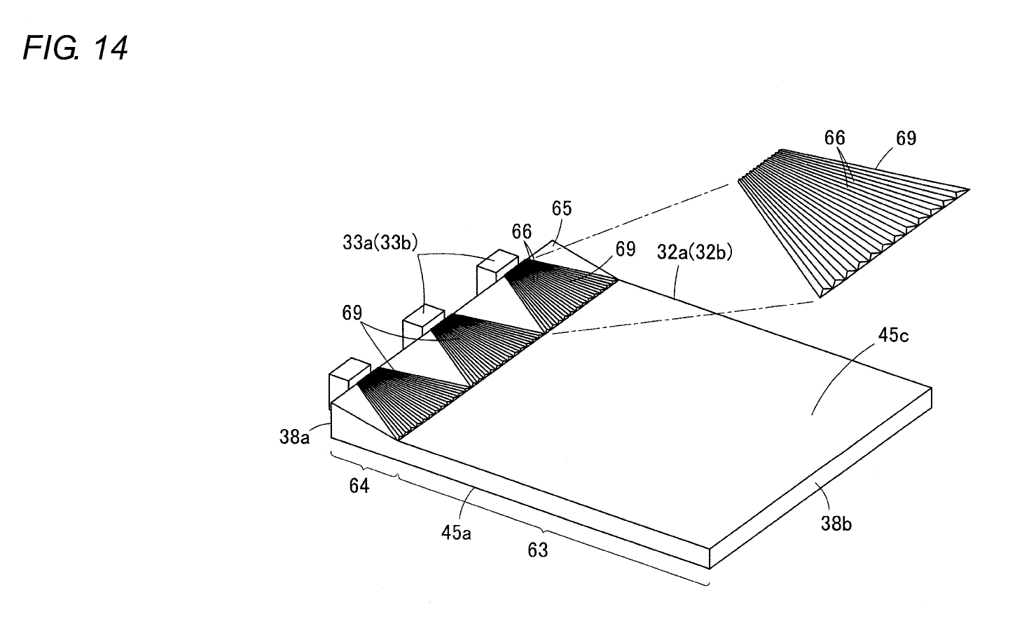

FIG. 14 is a perspective view showing another further example of the light guide plate 32a (or light guide plate 32b) for use in the area light source device 61 of the second embodiment. In the light guide plate 32a (or light guide plate 32b) of FIG. 14, a pattern region 69 having a substantially fan shape is formed at the inclined surface 65 of the light transitioning unit 64 on the front side of the left light source 33a (or right light source 33b). In each pattern region 69, a great number of microscopic V grooves 66 is radially formed. The V groove 66 on the front side of each left light source 33a (or right light source 33b) is radially formed with the light emitting point of the respective light source 33a (or light source 33b) or a point in the vicinity thereof as the center when viewed from a direction perpendicular to the flat surfaces 45a, 45c. Even when such light guide plates 32a, 32b are used, the light that entered the inclined surface 65 from the light introducing unit 62 side can be regressively reflected by the V groove 66, so that the light leaked from the inclined surface 65 in the middle of guiding the light that entered the light introducing unit 62 to the light guide plate main body 63 can be reduced thereby enhancing the light usage efficiency. Therefore, the luminance of the area light source device 61 can be enhanced.

In the light guide plates 32a, 32b of FIG. 14, the light introducing unit 62 is not arranged, but the light introducing unit 62 may be arranged at the end of the light guide plate 32a, 32b.

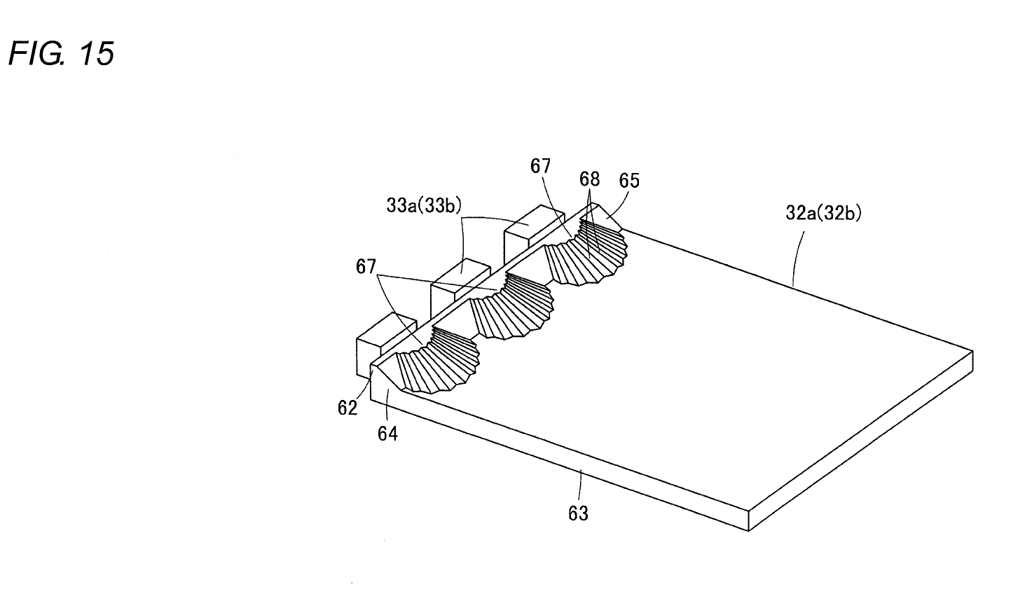

FIG. 15 is a perspective view showing another further example of the light guide plate 32a (or light guide plate 32b) for use in the area light source device 61 of the second embodiment. In the light guide plate 32a (or light guide plate 32b) of FIG. 15, a bulging portion 67 having a substantially semicircular truncated shape is arranged on the inclined surface 65 of the light transitioning unit 64 at the position corresponding to each left light source 33a (or each right light source 33b). A great number of V grooves 68 is continuously formed on the outer peripheral surface of the bulging portion 67. In such light guide plate 32a, 32b, each V groove 68 is radially lined with each light source 33a, 33b as the center when viewed from a direction perpendicular to the light guide plate 32a, 32b, so that the light leaked from the inclined surface 65 in the middle of guiding the light that entered the light introducing unit 62 to the light guide plate main body 63 can be reduced thereby further enhancing the light usage efficiency.

### Third Embodiment

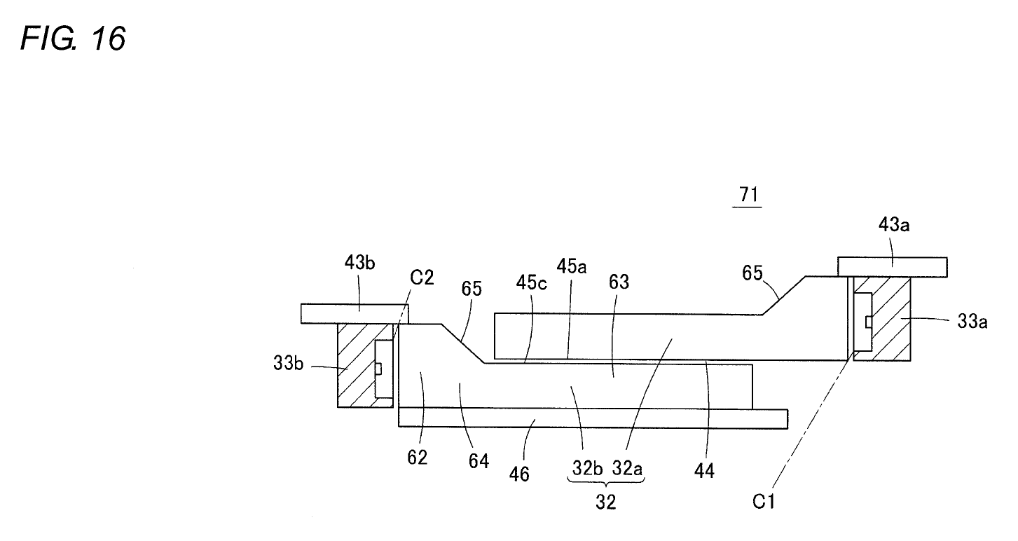

FIG. 16 is a schematic cross-sectional view showing an area light source device 71 according to a third embodiment of the present invention. Even in such area light source device 71, the light guide plate 32a and the light guide plate 32b are overlapped to form the light guide body 32 as shown in FIG. 12, 13, 14 or 15. However, in the area light source device 71, the flat surface 45a of the light guide plate 32a is overlapped on the front surface of the flat surface 45c of the light guide plate 32b with the low refraction index layer 44 interposed therebetween.

In such mode as well, the light guide plate 32a is arranged retracted from the end face 38a of the light guide plate 32b so as to fit within the region that becomes the shade of the light guide plate 32b, and the light guide plate 32b is arranged retracted from the end face 38a of the light guide plate 32a so as to fit within the region that becomes the shade of the light guide plate 32a. Therefore, the stereoscopic video can be cleared while suppressing the crosstalk in the stereoscopic display device.

The thickness of the light guide body 32 can be thinned by the dropped amount of the inclined surface 65 of the light guide plate 32b, and hence the thickness increases compared to the area light source device 61 of the second embodiment but the thickness of the area light source device 71 can be thinned compared to the area light source device 81 of the fourth embodiment to be described later.

### Fourth Embodiment

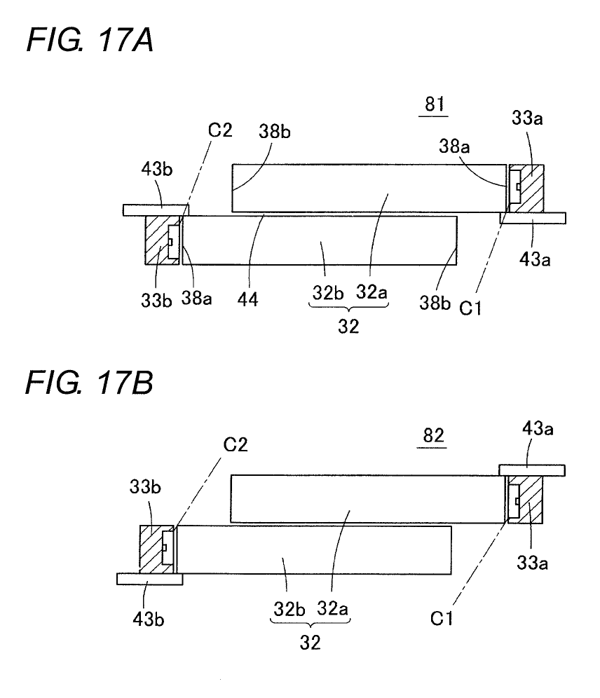

FIG. 17A is a schematic cross-sectional view showing an area light source device 81 according to the second embodiment of the present invention. In such area light source device 81, the light guide plate 32a and the light guide plate 32b having a parallel plate shape in which the front and the back are parallel surfaces are overlapped to form the light guide body 32. A microscopic optical pattern (e.g., prism pattern depressed to triangular cross-section, etc.) for exiting the light to the outside from the light exit surface (surface facing the liquid crystal panel side of the front surface and the back surface) of the light guide plate 32a is formed on at least one surface of the front surface or the back surface of the light guide plate 32a. Similarly, a microscopic optical pattern for exiting the light to the outside from the light exit surface is also formed on at least one surface of the front surface or the back surface of the light guide plate 32b.

The left light source 33a faces one end face 38a (light incident surface) of the light guide plate 32a, and the right light source 33b faces one end face 38a (light incident surface) of the light guide plate 32b. The light guide plate 32a is arranged to be retracted from the end face 38a of the light guide plate 32b so as to fit within the region that becomes the shade of the light guide plate 32b. The light guide plate 32b is arranged to be retracted from the end face 38a of the light guide plate 32a so as to fit within the region that becomes the shade of the light guide plate 32a. Therefore, in the area light source device 81 as well, the light of the left light source 33a (or right light source 33b) can be prevented from entering the light guide plate 32b (or light guide plate 32a) and becoming a stray light, so that the stereoscopic video becomes clear while suppressing the crosstalk in the stereoscopic display device.

In the area light source device 81 of FIG. 17A, the flexible print substrate 43b mounted with the right light source 33b can be positioned on the inner surface side (overlapping surface side with the light guide plate 32a) of the light guide plate 32b since the end face 38b of the light guide plate 32a is retracted than the end face 38a of the light guide plate 32b. Furthermore, the flexible print substrate 43a mounted with the left light source 33a can be positioned on the inner surface side (overlapping surface side with the light guide plate 32b) of the light guide plate 32a since the end face 38b of the light guide plate 32b is retracted than the end face 38a of the light guide plate 32a. As a result, the flexible print substrates 43a, 43b do not project out to the outer surface side of the light guide plates 32a, 32b, and hence the thickness of the area light source device 81 can be thinned compared to when the flexible print substrates 43a, 43b are positioned on the outer surface side of each of the light guide plates 32a, 32b, as in the area light source device 82 shown in FIG. 17B.

### Variant of Fourth Embodiment

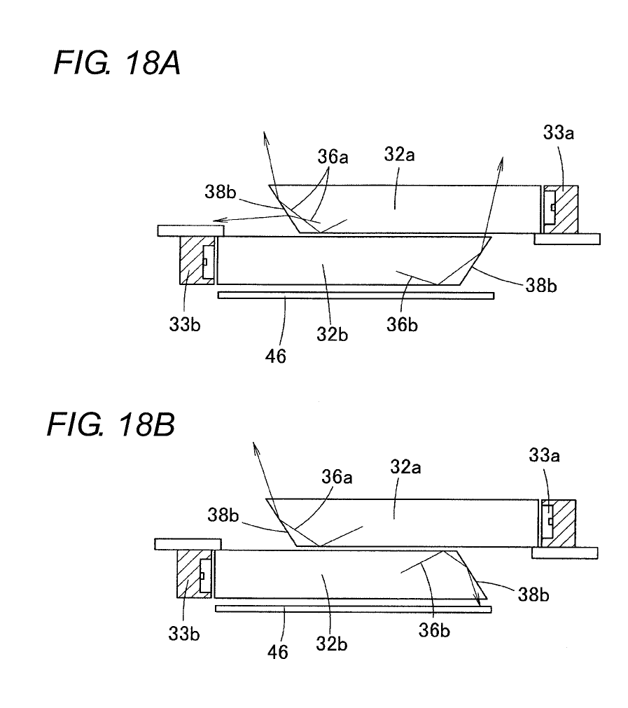

FIGS. 18A and 18B are views showing a variant of the fourth embodiment of the present invention. The end faces 38b of the flat plate shaped light guide plates 32a, 32b are tilted to be non-parallel to the end faces 38a.

In the area light source device of FIG. 18A, the end face 38b of the light guide plate 32a is inclined to become farther away from the end face 38a towards the front side (liquid crystal panel side). Therefore, the light guided through the light guide plate 32a and reached the end face 38b is totally reflected at the end face 38b and is less likely to be returned in the original direction, and is easily exit to the outside of the light guide plate 32a by being totally reflected at the end face 38b or by transmitting through the end face 38b. The end face 38b of the light guide plate 32b is also inclined to become farther away from the end face 38a towards the front side. Therefore, the light guided through the light guide plate 32b and reached the end face 38b is totally reflected at the end face 38b and is less likely to be returned in the original direction, and is easily exit to the outside of the light guide plate 32b by being totally reflected at the end face 38b or by transmitting through the end face 38b.

In the area light source device of FIG. 18B, the end face 38b of the light guide plate 32a is inclined to become farther away from the end face 38a towards the front side. Therefore, the light guided through the light guide plate 32a and reached the end face 38b is totally reflected at the end face 38b and is less likely to be returned in the original direction, and is easily exit to the outside of the light guide plate 32a by being totally reflected at the end face 38b or by transmitting through the end face 38b. The end face 38b of the light guide plate 32b is inclined to become closer to the end face 38a towards the front side. Therefore, the light guided through the light guide plate 32b and reached the end face 38b is totally reflected at the end face 38b and is less likely to be returned in the original direction, and is easily exit to the outside of the light guide plate 32b by being totally reflected at the end face 38b or by transmitting through the end face 38b.

In the area light source device as shown in FIGS. 18A and 18B, the light totally reflected at the end face 38b becomes the return light to return to the original direction and is exit in a direction different from the original direction so as to be prevented from becoming the cause of crosstalk. Since the end face 38b is merely inclined when manufacturing a die for molding the light guide plates 32a, 32b, the manufacturing cost can be suppressed.

The direction of inclining the end face 38b is not limited to those shown in FIGS. 18A and 18B.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. An area light source device comprising:
a first light guide plate;
a first light source arranged facing a first end of the first light guide plate;
a second light guide plate; and
a second light source arranged facing a first end of the second light guide plate, the first light guide plate and the second light guide plate being overlapped to configure a light guide body; wherein
the first light guide plate and the second light guide plate are overlapped so that the first end face of the first light guide plate and a second end face positioned on an opposite side of the first end face of the second light guide plate are positioned on the same side, and a second end face positioned on an opposite side of the first end face of the first light guide plate and the first end face of the second light guide plate are positioned on the same side; and
the second end face of the first light guide plate is shifted towards the second end face of the second light guide late than the first end face of the second light guide plate.

2. The area light source device according to claim 1, wherein the second end face of the second light guide plate is shifted towards the second end face of the first light guide plate from the first end face of the first light guide plate.

3. An area light source device comprising:
a first light guide plate;
a first light source arranged facing a first end of the first light guide plate;
a second light guide plate; and
a second light source arranged facing a first end of the second light guide plate, the first light guide plate and the second light guide plate being overlapped to configure a light guide body; wherein
the first light guide plate and the second light guide plate are overlapped so that the first end face of the first light guide plate and a second end face positioned on an opposite side of the first end face of the second light guide plate are positioned on an identical side, and a second end face positioned on an opposite side of the first end face of the first light guide plate and the first end face of the second light guide plate are positioned on an identical side; and
the first light guide plate is positioned in a region optically hidden by the first end face of the second light guide plate when viewed from the second light source.

4. The area light source device according to claim 3, wherein the second light guide plate is positioned in a region optically hidden by the first end face of the first light guide plate when viewed from the first light source.

5. The area light source device according to claim 1, further comprising:
a first wiring substrate mounted with the first light source and a second wiring substrate mounted with the second light source;
wherein at least one part of the second wiring substrate is arranged in a space formed in a vicinity of the first end face in a surface on the side of the second light guide plate where the first light guide plate is overlapped.

6. The area light source device according to claim 3, further comprising:
a first wiring substrate mounted with the first light source and a second wiring substrate mounted with the second light source;
wherein at least one part of the second wiring substrate is arranged in a space formed in a vicinity of the first end face in a surface on the side of the second light guide plate where the first light guide plate is overlapped.

7. The area light source device according to claim 2, further comprising:
a first wiring substrate mounted with the first light source and a second wiring substrate mounted with the second light source;
wherein at least one part of the first wiring substrate is arranged in a space formed in a vicinity of the first end face in a surface on the side of the first light guide plate where the second light guide plate is overlapped.

8. The area light source device according to claim 4, further comprising:
a first wiring substrate mounted with the first light source and a second wiring substrate mounted with the second light source; wherein
at least one part of the first wiring substrate is arranged in a space formed in a vicinity of the first end face in a surface on the side of the first light guide plate where the second light guide plate is overlapped.

9. The area light source according to claim 1, wherein a light absorbing member is arranged on the second end face of at least one of the second end face of the first light guide plate or the second end face of the second light guide plate.

10. The area light source according to claim 3, wherein a light absorbing member is arranged on the second end face of at least one of the second end face of the first light guide plate or the second end face of the second light guide plate.

11. The area light source device according to claim 1, wherein the second end face of the light guide plate is tilted with respect to the first end face of the light guide plate in at least one light guide plate of the first light guide plate and the second light guide plate.

12. The area light source device according to claim 3, wherein the second end face of the light guide plate is tilted with respect to the first end face of the light guide plate in at least one light guide plate of the first light guide plate and the second light guide plate.

13. A stereoscopic display device comprising:
an area light source device according to claim 1;
an optical sheet and a liquid crystal panel arranged on a front side of the liquid crystal panel; and
a synchronous drive device for alternately switching a display of the liquid crystal panel to a right eye image and a left eye image and alternately switching light-ON or light-OFF of the first light source and the second light source of the area light source device in synchronization with the switching of the image.

14. A stereoscopic display device comprising:
an area light source device according to claim 3;
an optical sheet and a liquid crystal panel arranged on a front side of the liquid crystal panel; and
a synchronous drive device for alternately switching a display of the liquid crystal panel to a right eye image and a left eye image and alternately switching light-ON or light-OFF of the first light source and the second light source of the area light source device in synchronization with the switching of the image.
